(19) United States
(12) Patent Application Publication
(10) Pub. No.: US 2002/0039648 A1
(43) Pub. Date: Apr. 4, 2002

(54) Polyelectrolyte coated permeable composite material, its preparation and use

(76) Inventors: Gerhard Horpel, Nottuln (DE); Christian Hying, Rhede (DE); Bernd Tieke, Bruhl (DE); Lutz Krasemann, Koln (DE); Ali Toutianoush, Koln (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/891,314

(22) Filed: Jun. 27, 2001

(30) Foreign Application Priority Data
Jun. 27, 2000 (DE) 10 031 281.0

(51) Int. Cl. B32B 5/14; B05D 3/02

(52) U.S. Cl. 428/307.7; 427/372.2

(57) ABSTRACT

Polyelectrolyte coated permeable composite materials are prepared by coating a polyelectrolyte onto a composite material comprising an inorganic component composed of at least one compound of a metal, semimetal or mixed metal with at least one element from main groups 3 to 7, disposed on at least one side and on inner surfaces of a permeable support. The surface of the composite material is charged, and at least one, or a plurality of polyelectrolyte layers are deposited on the composite material to provide a polyelectrolyte coated permeable composite material. These a polyelectrolyte coated permeable composite materials are particularly useful as membranes for separating alcohol/water mixture

### BACKGROUND OF THE INVENTION

1. Field of the Invention

The present invention relates to a polyelectrolyte coated permeable composite material and to its preparation and use.

2. Discussion of the Background

Permeable composite materials have diverse possible applications. For example, materials of this kind are especially suitable for use as membranes. Membranes for separating, for example, ethanol/water mixtures by pervaporation have been thoroughly described in the literature. Commercially available products are based on membranes having a multilayer construction. They consist of a highly porous polymer support structure (usually a polyacrylonitrile membrane on a polyester nonwoven) to which a crosslinked polyvinyl alcohol layer has been applied. This layer usually possesses a thickness of a few micrometers. Additional polymers suitable for preparing a selective top layer include block copolymers of polyols and polyurethanes. Recently, there has also been increasing use of inorganic materials, in particular membranes having zeolite top layers and also silica layers. Composite materials such as zeolite filled polysiloxanes have also been investigated in detail (R. Y. M. Huang (Ed.), “Pervaporation Membrane Separation Processes”, Elsevier, Amsterdam 1991).

Moreover, membranes having polyelectrolyte layers as selective layers has been frequently described in the literature (K. Richau, H. -H. Schwarz, R. Apostol, D. Paul; J. Membr. Sci. 113, (1996) 31, Sang Yong Nam, Young Moo Lee; J. Membr. Sci. 135 (1997) 161 and P. Stroeve; V. Vasquez; M. A. N. Coelho; J. F. Rabolt; Thin Solid Films 284/285 (1996) 706). In particular, the method of preparing self-organized polyelectrolyte layers, as has been proposed by a number of authors (F. van Ackem; L. Krasemann; B. Tieke; Thin Solid Films 327-329 (1998) 762 and L. Krasemann; B. Tieke; J. Membr. Sci. 150 (1998) 23), is extremely suitable for preparing particularly thin layers. Since the flow through a membrane is in inverse proportion to the layer thickness of the membrane, a high flow can be achieved through such a membrane. Such polyelectrolyte layers are normally deposited on polyacrylonitrile supports activated by plasma treatment, as also used for polyvinyl alcohol membranes.

EP 0 472 990 describes the deposition of a monolayer of polyelectrolytes on symmetrical organic or inorganic surfaces which are not permeable and therefore cannot be used as membranes.

All of the above membrane systems have a number of disadvantages. The polymer membranes and the zeolite filled polymer membranes lack the temperature stability required to achieve consistent separations at temperatures above 80° C. The zeolitic and silica coated inorganic membranes, which operate very well at higher temperatures, are correspondingly expensive and of scant commercial availability. Moreover, they are highly susceptible to acidic media, which destroy the selective layers of these membranes within a few minutes or a few hours. Additionally, the inorganic membranes are generally inflexible and are therefore easily destroyed under tensile or torsional stress.

### SUMMARY OF THE INVENTION

It is an object of the present invention, therefore, to provide a composite material which provides good separations and is durable at relatively high temperatures and/or at a pH <7.

It is another object of the present invention to provide a process for preparing the composite material.

It is a third object of the present invention to separate mixtures by a pervaporation process, comprising contacting the composite material with a liquid mixture.

### BRIEF DESCRIPTION OF THE DRAWINGS

FIG. 1 is a graph of the permeate flow from a pervaporation membrane at a temperature of 80° C. as a function of the initial water content of the ethanol/water feed.

FIG. 2 is a graph of the water content of the permeate (% by weight), membrane at a temperature of 80° C., as a function of the initial water content of the ethanol/water feed.

FIG. 3 is a graph of the permeate flow from a pervaporation membrane at a temperature of 105-110° C. as a function of the initial water content of the ethanol/water feed.

FIG. 4 is a graph of the water content of the permeate (% by weight), membrane at a temperature of 105-110° C., as a function of the initial water content of the ethanol/water feed.

### DETAILED DESCRIPTION OF THE INVENTION

It has surprisingly been found that polyelectrolyte layers may be deposited not only on organic support materials or on symmetrical surfaces (by symmetrical surfaces, we mean surfaces having uniform density or porosity), but also on permeable inorganic—including ceramic—surfaces. A polyelectrolyte coated permeable composite material of this kind, having at least one perforated and permeable support comprising on at least one side of the support and in the interior of the support at least one inorganic component comprising substantially at least one compound of a metal, semimetal or mixed metal with at least one element from main groups 3 to 7, may be used as a pervaporation membrane even at relatively high temperatures and at a pH <7.

In a first embodiment, the present invention provides a permeable composite material comprising at least one perforated and permeable support comprising on at least one side of the support, and in the interior of the support, at least one inorganic component comprising at least one compound of a metal, semimetal or mixed metal with at least one element from main groups 3 to 7, and having at least one polyelectrolyte layer on the inner and/or outer surfaces thereof.

The polyelectrolyte coated composite material of the present invention is highly suitable as a membrane for pervaporation. Owing to the particular structure of the polyelectrolyte coated composite material of the present invention, membranes of particularly good chemical and thermal stability are provided, which also exhibit very high flow rates and separation factors.

The composite material of the invention is described by way of the examples below, without being restricted thereto.

The permeable composite materials of the present invention comprising at least one perforated and permeable support comprising on at least one side of the support, and in the interior of the support, at least one inorganic component comprising at least one compound of a metal, semimetal or mixed metal with at least one element from main groups 3 to 7, and having at least one polyelectrolyte layer on the inner and/or outer surfaces thereof. By the interior of a support is meant, for the purposes of the present invention, the cavities or pores in a support.

The perforated and permeable support can have interstices with a size of from 5 nm to 500 μm, preferably with a size of from 50 nm to 50 μm, and particularly preferably with a size of from 50 nm to 5 μm. The interstices may be pores, meshes, holes, crystal lattice interstices, or cavities. The support may comprise at least one material selected from carbon, metals, alloys, glass, ceramics, minerals, plastics, amorphous substances, natural products, composites, or of at least one combination of two or more of these materials. The supports comprising the aforementioned materials may also have been modified by a chemical, thermal or mechanical treatment method, or by a combination of treatment methods. Preferably, the composite material comprises a support comprising at least one metal, natural fiber or polymer which has been modified by at least one mechanical deformation technique or treatment method, such as drawing, compressing, flexing, rolling, stretching or forging, for example. Particularly preferably, the composite material comprises at least one support comprising at least woven, bonded, felted or ceramically bound fibers, or comprising sintered or bonded moldings, beads or particles. In a further preferred embodiment, a perforated support may be used. Permeable supports may also be those which acquire their permeability, or have been made permeable, by laser treatment or ion beam treatment.

It may be advantageous for the support to comprise fibers of at least one material selected from carbon, metals, alloys, ceramics, glass, minerals, plastics, amorphous substances, composites and natural products or fibers of a combination of two or more of these materials, such as asbestos, glass fibers, carbon fibers, metal wires, including steel wires, rock wool fibers, polyamide fibers, coconut fibers, and coated fibers, for example. It is preferred to use supports which comprise woven fibers of metal or alloys. Wires may also be used as metal fibers. Particularly preferably, the composite material comprises a support comprising at least one woven fabric made of steel or of stainless steel, such as woven fabrics produced from steel wires, steel fibers, stainless steel wires or stainless steel fibers by weaving, and having a mesh size of preferably from 5 to 500 μm, preferably from 5 to 50 or from 50 to 500 μm, and particularly preferably from 70 to 120 μm.

Alternatively, the support of the composite material may comprise at least one expanded metal having a pore size of from 5 to 500 μm. In accordance with the invention, however, the support may also comprise at least one particulate sintered metal, a sintered glass or a metal nonwoven having a pore size of from 0.1 μm to 500 μm, preferably from 3 to 60 μm.

The composite material of the invention preferably comprises at least one support comprising at least aluminum, silicon, cobalt, manganese, zinc, vanadium, molybdenum, indium, lead, bismuth, silver, gold, nickel, copper, iron, titanium, platinum, stainless steel, steel, brass, an alloy of these materials, or a material coated with Au, Ag, Pb, Ti, Ni, Cr, Pt, Pd, Rh, Ru and/or Ti.

The inorganic component present in the composite material of the invention may comprise at least one compound of at least one metal, semimetal or mixed metal, with at least one element from main groups 3 to 7 of the Periodic Table or at least one mixture of these compounds. The compounds of the metals, semimetals or mixed metals may comprise at least elements of the transition group elements and from main groups 3 to 5 or at least elements of the transition group elements or from main groups 3 to 5, these compounds having a particle size of from 0.001 to 25 μm. The inorganic component preferably comprises at least one compound of an element from transition groups 3 to 8 and/or at least one element from main groups 3 to 5 with at least one of the elements Te, Se, S, O, Sb, As, P, N, Ge, Si, C, Ga, Al or B, or mixture of these compounds. Particularly preferably, the inorganic component comprises at least one compound of at least one of the elements Sc, Y, Ti, Zr, V, Nb, Cr, Mo, W, Mn, Fe, Co, B, Al, Ga, In, Tl, Si, Ge, Sn, Pb, Sb or Bi with at least one of the elements Te, Se, S, O, Sb, As, P, N, C, Si, Ge or Ga, such as TiO₂, Al₂P₃, SiO₂, ZrO₂, Y₂O₃, BC, SiC, Fe₃O₄, SiN, SiP, nitrides, sulfates, phosphides, suicides, spinels or yttrium aluminum garnet, or one of these elements itself. The inorganic component may also comprise aluminosilicates, aluminum phosphates, zeolites or partially exchanged zeolites, such as ZSM-5, Na-ZSM-5 or Fe-ZSM-5, for example, or amorphous microporous mixed oxides which may include up to 20% of nonhydrolyzable organic compounds, such as, for example, vanadium oxide-silicon oxide glass or aluminum oxide-silicon oxide-methylsilicon sesquioxide glasses.

Preferably, the particle size of at least one inorganic component lies within a particle size fraction having a particle size of from 1 to 250 nm or having a particle size of from 260 to 10,000 nm.

It may be advantageous for the composite material of the present invention to comprise at least two particle size fractions of at least one inorganic component. It may likewise be advantageous for the composite material of the present invention to comprise at least two particle size fractions of at least two inorganic components. The particle size ratio may be from 1:1 to 1:10,000, preferably from 1:1 to 1:100. The quantitative ratio of the particle size fractions in the composite material may be preferably from 0.01:1 to 1:0.01.

The permeability of the composite material of the invention is limited to particles having a certain maximum size, by the particle size of the inorganic component used.

A feature of the composite material of the present invention is that it comprises at least one organic and/or inorganic material which has surface charges.

This material may be present in the form of an admixture in the microstructure of the composite material. Alternatively, it may also be advantageous for the inner and/or outer surfaces of the particles present in the composite material to be coated with a layer of an organic and/or inorganic material which has surface charges. Such layers may have a thickness of from 0.0001 to 1 μm, preferably a thickness of from 0.001 to 0.05 μm.

In one particular embodiment of the composite material of the present invention, at least one organic and/or inorganic material which has surface charges is present in the interparticulate volume of the composite material. This material fills some or all, preferably some, of the interparticulate volume.

The surfaces of the organic and/or inorganic materials have ionic groups on which at least one polyelectrolyte layer can be adsorbed.

It may be advantageous for the material which has surface charges to comprise ionic groups selected from the group consisting of alkylsulfonic acid, sulfonic acid, phosphoric acid, alkylphosphonic acid, dialkylphosphinic acid, carboxylic acid, tetraorganylammonium, organylsulfonium, organylphosphonium and tetraorganylphosphonium groups or mixtures of these groups having the same charge. These ionic groups may be organic compounds attached chemically and/or physically to inorganic particles. Preferably, the ionic groups are connected to the inner and/or outer surface of the particles present in the composite material by way of aryl and/or alkyl chains.

The material which has surface charges in the composite material may be an organic material, such as a polymer, for example. Polymers containing strongly basic or strongly acidic functional groups are preferred, and polymers comprising a sulfonated polytetrafluoroethylene, a sulfonated polyvinylidene fluoride, an aminated polytetrafluoroethylene, an aminated polyvinylidene fluoride, a sulfonated polysulfone, an ainiated polysulfone, a sulfonated polyetherimide, an aminated polyetherimide, or a mixture of these polymers, are particularly preferred.

The composite material may comprise at least one inorganic material which has surface charges, selected from the group consisting of oxides, phosphates, phosphites, phosphonates, sulfates, sulfonates, vanadates, stannates, plumbates, chromates, tungstates, molybdates, manganates, titanates, silicates, aluminosilicates and aluminates or mixtures of these compounds of at least one of the elements Al, K, Na, Ti, Fe, Zr, Y, Va, W, Mo, Ca, Mg, Li, Cr, Mn, Co, Ni, Cu and Zn or mixtures of these elements.

Alternatively, the inorganic material which has surface charges may comprise at least one partially hydrolyzed compound from the group consisting of oxides, phosphates, phosphites, phosphonates, sulfates, sulfonates, vanadates, stannates, plumbates, chromates, tungstates, molybdates, manganates, titanates, silicates, aluminosilicates and aluminates or mixtures of these compounds of at least one of the elements Al, K, Na, Ti, Fe, Zr, Y, Va, W, Mo, Ca, Mg, Li, Cr, Mn, Co, Ni, Cu and Zn or a mixture of these elements. Preferably, the inorganic material which carries surface charges in the composite material of the invention is at least one amorphous and/or crystalline compound, having groups, some of which cannot be hydrolyzed, of at least one of the elements Zr, Si, Ti, Al, Y or vanadium or mixtures of these elements or compounds.

The polyelectrolyte layer or polyelectrolyte coating present on the inner and/or outer surfaces of the composite material of the present invention comprises polyelectrolytes which carry negative and/or positive charges. Preferably, the polyelectrolyte layer comprises, in alternation, anionic and cationic or cationic and anionic polyelectrolytes.

It may also be advantageous for the polyelectrolyte layer to comprise at least one polyelectrolyte which has anionic and cationic properties. Polyalphaaminoacrylic acid, for example, may be such a polyelectrolyte which has anionic and cationic properties.

Preferably, the polyelectrolyte layer comprises at least one polyelectrolyte from the group which includes polyallylamine hydrochloride, polyethyleneimine, polyvinylamine, polyvinyl sulfate potassium salt, polystyrenesulfonate sodium salt, and polyacrylamido-2-methyl-1-propanesulfonic acid.

Particularly preferably, the polyelectrolyte layer has a ratio of carbon atoms to possible ion pair bonds of from 2:1 to 20:1, preferably from 4:1 to 8:1. For example, a polyvinyl complex comprising polyvinyl sulfate and polyvinylamine has a ratio of 4. Heteroatoms that replace carbon atoms, for example the silicon atoms in organosilicon compounds, may be treated like carbon atoms in regard to the above-described ratio.

The composite material of the invention may be flexible. Preferably, the polyelectrolyte coated composite material may be bent to a minimum radius of 5 mm, preferably to a minimum radius of 1 mm, without breaking.

In a second embodiment, the present invention provides a process for preparing a composite material which comprises coating at least once with a polyelectrolyte, a composite material which has surface charges and which comprises at least one perforated and permeable support comprising on at least one side of the support and/or in the interior of the support at least one inorganic component comprising at least one compound of a metal, semimetal or mixed metal with at least one element from main groups 3 to 7.

The process of the present invention for preparing a composite material which has a polyelectrolyte layer on the inner and/or outer surfaces is described by way of example below, without any intention to restrict the process of the invention to this preparation.

The process of the present invention for preparing a composite material of the present invention, comprises coating, at least once with a polyelectrolyte, a composite material which has surface charges and which comprises at least one perforated and permeable support comprising on at least one side of the support and/or in the interior of the support at least one inorganic component comprising at least one compound of a metal, semimetal or mixed metal with at least one element from main groups 3 to 7.

The composite material which has surface charges may be provided in a variety of ways. First, materials which have surface charges or materials which have surface charges after being further treated may be used in the preparation of the composite material of the present invention. Second, existing permeable composite materials may be treated with materials which have surface charges or with materials which have surface charges after additional treatment.

Composite materials which have surface charges may be produced by means of the preparation process described in detail in PCT/EP98/05939, herein incorporated by reference. In this process, at least one suspension comprising at least one inorganic component of at least one compound of at least one metal, semimetal or mixed metal with at least one of the elements from main groups 3 to 7 is brought into and onto at least one perforate and permeable support. The suspension is solidified on and/or in the support material by heating at least once.

In this process it may be advantageous to bring the suspension onto and/or into at least one support by means of printing, pressing, injecting, rolling, knife coating, brushing, dipping, spraying, or pouring.

The perforated and permeable support onto and/or into which at least one suspension is brought, may comprise at least one material selected from carbon, metals, alloys, ceramics, minerals, plastics, amorphous substances, natural products, composites, composite materials, or of at least one combination of these materials. Such permeable support materials may also include those which have been made permeable by treatment with laser beams or ion beams. The supports are preferably woven fabrics of fibers or wires of the above materials, such as, for example, woven metal or woven polymer.

The suspension may comprise at least one inorganic component and at least one metal oxide sol, at least one semimetal oxide sol or at least one mixed metal oxide sol, or a mixture of these sols, and may be prepared by suspending at least one inorganic component in at least one of these sols. The sols are obtained by hydrolyzing at least one compound, preferably at least one metal compound, at least one semimetal compound or at least one mixed metal compound, with at least one liquid, solid or gas. For example, may be advantageous for the liquid to be water, alcohol or an acid, for example, for the solid to be ice, or for the gas to be water vapor, or at least one combination of these liquids, solids or gases. It may likewise be advantageous for the compound to be hydrolyzed to be added, prior to the hydrolysis, to alcohol or an acid or combination of these liquids. The compound to be hydrolyzed is preferably at least one metal nitrate, metal chloride, metal carbonate, metal alkoxide compound or at least one semimetal alkoxide compound, with particular preference for at least one metal alkoxide compound, metal nitrate, metal chloride, metal carbonate, or at least one semimetal alkoxide compound, selected from the compounds of the elements Ti, Zr, Al, Si, Sn, Ce and Y or from the lanthanoids and actinoids, such as for example titanium alkoxides, titanium isopropylate, silicon alkoxides, zirconium alkoxides, or a metal nitrate, such as zirconium nitrate.

It may also be advantageous to carry out the hydrolysis using at least half the molar ratio of water, water vapor or ice, based on the molar amount of the hydrolyzable group of the hydrolyzable compound.

The hydrolyzed compound may be peptized by treatment with at least one organic or inorganic acid, preferably an organic or inorganic acid having a strength of from 10 to 60%, and preferably with a mineral acid selected from sulfuric acid, hydrochloric acid, perchloric acid, phosphoric acid and nitric acid or a mixture of these acids.

It is possible to use not only the sols prepared as described above, but also commercial sols, such as, for example titanium nitrate sol, zirconium nitrate sol or silica sol.

It may be advantageous for at least one inorganic component having a particle size of from 1 to 10,000 nm to be suspended in at least one sol, preferably an inorganic component comprising at least one compound selected from metal compounds, semimetal compounds, mixed metal compounds and metal mixed compounds with at least one of the elements from main groups 3 to 7, or at least one mixture of these compounds, particularly preferably at least one inorganic component comprising at least one compound from the oxides of the transition group elements or the elements of main groups 3 to 5, preferably oxides selected from the oxides of the elements Sc, Y, Ti, Zr, Nb, Ce, V, Cr, Mo, W, Mn, Fe, Co, B, Al, In, Tl, Si, Ge, Sn, Pb and Bi, such as, for example, Y₂O₃, ZrO, Fe₂O₃, Fe₃O₄, Sio₂ and Al₂O₃. The inorganic component may also comprise aluminosilicates, aluminum phosphates, zeolites, including partially exchanged zeolites, such as ZSM-5, Na-ZSM-5 or Fe-ZSM-5, for example, or amorphous microporous mixed oxides, with or without up to 20% of nonhydrolyzable organic compounds, such as, for example, vanadium oxide-silicon oxide glass or aluminum oxide-silicon oxide-methylsilicon sesquioxide glasses. The mass fraction of the suspended component is preferably from 0.1 to 500 times that of the hydrolyzed compound used.

The crack resistance of the composite material may be optimized through the appropriate choice of the particle size of the suspended compounds relative to the size of the pores, holes or interstices of the perforate permeable support, and also through the layer thickness of the composite material of the present invention and through the proportional sol/solvent/metal oxide ratio.

When using a woven mesh having a mesh size of, for example, 100 μm, it is possible to increase the crack resistance by using, preferably, suspensions comprising a suspended compound having a particle size of at least 0.7 μm. In general, the ratio of particle size to mesh size or pore size should be from 1:1000 to 50:1000. The composite material of the invention may preferably have a thickness of from 5 to 1000 μm, with particularly preferably from 50 to 150 μm. The suspension comprising the sol and compounds to be suspended preferably has a ratio of sol to compounds to be suspended of from 0.1:100 to 100:0.1, preferably from 0.1:10 to 10:0.1 parts by weight.

The suspension present on and/or in the support may be solidified by heating the combination of support and suspension at from 50 to 1000° C. In one particular embodiment of the process, the assembly (i.e., combination of support and suspension) is exposed to a temperature of 50 to 100° C. for from 10 minutes to 5 hours. In another particular embodiment of the process of the invention, the assembly is exposed to a temperature of from 100 to 800° C. for from 1 second to 10 minutes, preferably a temperature of from 350 to 600° C. for from 30 seconds to 4 minutes.

The assembly may be heated by means of heated air, hot air, infrared radiation, microwave radiation, or electrically generated heat. In one particular embodiment of the process of the invention, it may be advantageous for the assembly to be heated using the support material as an electrical resistance heating element. For this purpose the support may be connected to a current source via at least two electrical contacts attached to the support. Depending on the power of the current source and the level of voltage applied, the support heats up when the current is switched on, and by means of this heating, the suspension present in and on the surface of the support may be solidified.

In a another, particularly preferred embodiment of the process of the present invention, the suspension may be solidified by bringing it onto and/or into a preheated support and so solidifying it directly after application.

The composite material of the present invention which has surface charges may also be produced by using at least one polymer-bound commercial Brönsted acid or Brönsted base during the preparation process described above. Preferably, the composite material which has surface charges may be obtained by using at least one sol which comprises polyelectrolyte solutions or polymer particles which have fixed charges. It may be advantageous for the polyelectrolytes or polymers which have fixed charges to have a melting point or softening point of below 500° C. The preferred polyelectrolytes or polymers which have fixed charges may comprise, for example, sulfonated polytetrafluoroethylene, sulfonated polyvinylidene fluoride, aminated polytetrafluoroethylene, aminated polyvinylidene fluoride, sulfonated polysulfone, aminated polysulfone, sulfonated polyetherimide, aminated polyetherimide, or a mixture thereof. The fraction of the polyelectrolytes or of the polymers which have fixed charges in the sol is preferably from 0.001% by weight to 50.0% by weight, with particularly preferably from 0.01% by weight to 25% by weight. During the production and processing of the ion-conducting composite material, the polymer may undergo chemical and/or physical changes.

The composite material which has surface charges may also be obtained by using a sol which comprises at least one material which has surface charges, or which has surface charges after being further treated, with the sol used during the preparation of the composite material. Preferably, materials are added to the sol to form inorganic layers which have surface charges on the inner and/or outer surfaces of the particles present in the composite material.

The sol may be obtained by hydrolyzing at least one metal compound, at least one semimetal compound, or at least one mixed metal compound, or a combination of these compounds, with a liquid, a gas and/or a solid. The preferred liquid, gas and/or solid for hydrolysis is water, water vapor, ice, alcohol or acid, or a combination of these compounds. It may be advantageous to add the compound to be hydrolyzed to alcohol and/or an acid prior to the hydrolysis. Preferably, at least one nitrate, chloride, carbonate or alkoxide of a metal or semimetal is hydrolyzed. Particularly preferably, the nitrate, chloride, carbonate or alkoxide to be hydrolyzed is a compound of the elements Ti, Zr, V, Mn, W, Mo, Cr, Al, Si, Sn and/or Y.

It may be advantageous if the compound to be hydrolyzed has nonhydrolyzable groups as well as hydrolyzable groups. Preferred compounds to be hydrolyzed include alkyltrialkoxy or dialkyldialkoxy or trialkylalkoxy compounds of silicon.

At least one water and/or alcohol soluble acid or base may be added to the sol to prepare the composite material, preferably an acid or base of the elements Na, Mg, K, Ca, V, Y, Ti, Cr, W, Mo, Zr, Mn, Al, Si, P or S.

The sol used to prepare the material which has surface charges may also comprise nonstoichiometric metal, semimetal or nonmetal oxides and/or hydroxides produced by changing the oxidation state of the corresponding element. The oxidation state may be changed by reaction with organic compounds or inorganic compounds or by means of electrochemical reactions. Preferably, the change in oxidation state is brought about by reaction with an alcohol, aldehyde, sugar, ether, olefin, peroxide or metal salt. Compounds having the ability to change oxidation state in this way may, for example, include compounds of Cr, Mn, V, Ti, Sn, Fe, Mo, W or Pb.

It may be advantageous to add substances to the sol which lead to the formation of inorganic structures which have surface charges. Examples of possible substances of this kind include zeolite particles and/or βaluminosilicate particles. In this way it is possible to prepare, for example, a permeable composite material which has surface charges composed almost exclusively of inorganic substances. In this context, the composition of the sol is particularly important, since it is necessary to use a mixture of different hydrolyzable components. The hydrolysis rate of the individual components must be carefully matched to one another. It is also possible to produce nonstoichiometric metal oxide hydrate sols by means of the corresponding redox reactions. The metal oxide hydrates of the elements Cr, M, V, Ti, Sn, Fe, Mo, W or Pb are very readily prepared in this way. The compounds which have surface charges on the inner and outer surfaces are then different, partially hydrolyzed or nonhydrolyzed oxides, phosphates, phosphites, phosphonates, stannates, plumbates, chromates, sulfates, sulfonates, vanadates, tungstates, molybdates, manganates, titanates, silicates or mixtures thereof of the elements Al, K, Na, Ti, Fe, Zr, Y, Va, W, Mo, Ca, Mg, Li, Cr, Mn, Co, Ni, Cu or Zn, or mixtures of these elements.

In another preferred embodiment of the process of the present invention, existing permeable composite materials, with or without surface charges, may be treated with materials which have surface charges, or with materials which carry surface charges, followed by additional treatment. Such composite materials may be conventional commercially available permeable materials or composite materials, or else may be composite materials as described, for example, in PCT/EP98/05939. It is, however, also possible to use the composite materials prepared by the process described above.

Permeable composite materials which have surface charges are obtained by treating a composite material which has a pore size of from 0.001 to 5 μm and no or an inadequate number of surface charges with at least one material which has surface charges which has surface charges following additional treatment.

The treatment of the composite material with at least one material which has surface charges or which has surface charges following additional treatment may be by impregnating, dipping, brushing, roller application, knife coating, spraying, or other coating techniques. Following this treatment, the composite material is preferably thermally treated, preferably at a temperature from 100 to 700° C.

Preferably, the material which has surface charges or which has surface charges following additional treatment is applied to the composite material in the form of a solution having a solvent content of from 1 to 99%. The material used to prepare the composite material which has surface charges may comprise polyorganylsiloxanes having at least one ionic constituent. The polyorganylsiloxanes may comprise, inter alia, polyalkyl- and/or polyarylsiloxanes and/or further constituents. It may also be advantageous if this material used to prepare the composite material comprises at least one Brönsted acid or Brönsted base. It may likewise be advantageous if the material used to prepare the composite material which has surface charges comprises at least one trialkoxysilane solution or suspension containing acidic and/or basic groups. Preferably, at least one of the acidic or basic groups is a quaternary ammonium, phosphonium, alkylsulfonic acid, carboxylic acid or phosphonic acid group. In this way, using the process of the present invention, it is possible for an existing conventional permeable composite material, for example, to be given surface charges by treatment with a silane. For this purpose, a 1-20% solution of this silane in a water-containing solution is prepared and the composite material is dipped therein. The solvents may be aromatic and aliphatic alcohols, aromatic and aliphatic hydrocarbons, and other common solvents or mixtures. The preferred solvents are ethanol, octanol, toluene, hexane, cyclohexane, and octane. After the adhering liquid has dripped away, the impregnated composite material is dried at about 150° C. and, either directly, or after repeated coating and drying at 150° C., may be used as a permeable composite material which has surface charges. Both silanes carrying cationic groups and silanes carrying anionic groups are suitable for this purpose.

It may further be advantageous for the solution or suspension for treating the composite material to comprise not only a trialkoxysilane but also acidic or basic compounds and water. Preferably the acidic or basic compounds include at least one Brönsted or Lewis acid or base known to the skilled worker.

Alternatively, the composite material may be treated with solutions, suspensions or sols comprising at least one material which has surface charges. This treatment may be performed once or may be repeated a number of times. In this embodiment of the process of the present invention, layers are obtained of one or more identical or different, partially hydrolyzed or nonhydrolyzed oxides, phosphates, phosphites, phosphonates, sulfates, sulfonates, vanadates, tungstates, molybdates, manganates, titanates, silicates or mixtures thereof of the elements Al, K, Na, Ti, Fe, Zr, Y, Va, W, Mo, Ca, Mg, Li, Cr, Mn, Co, Ni, Cu or Zn or mixtures of these elements.

The composite materials which have surface charges, obtained in accordance with the process of the present invention are coated from 1 to 500 times, preferably from 20 to 100 times, with at least one polyelectrolyte.

The polyelectrolytes may be applied by spraying, knife coating, rolling and/or dipping or similar processes, preferably as a solution. These solutions contain preferably from 0.001 to 2.0 mmol/l, with particularly preferably from 0.005 to 0.5 mmol/l, of the respective polyelectrolyte. Suitable solvents include acids, preferably dilute mineral acids, particularly preferably dilute hydrochloric acid. The solutions preferably contain the respective polyelectrolyte in a concentration of from 0.01 mmol/l in a dilute hydrochloric acid having a pH of about 1.7. Electrolytes, such as NaCl, NaClO₄ or KCl, for example, may be added during application of the polyelectrolyte solution. As electrolytes it is possible to use 1:1, 1:2 or 2:1 electrolytes, such as KCl, MgCl₂ or K₂SO₄, for example. The ionic strength of the electrolytes used in the polyelectrolyte solution is preferably from 0.02 to 10.

Preferably, the composite material of the present invention is prepared by coating a composite material which has surface charges alternately with at least one anionic polyelectrolyte and at least one cationic polyelectrolyte. Where the polyelectrolytes used, i.e., the polyanion and polycation, are the same in each dipping operation, layers having the structure ABABAB etc. are obtained. By varying the polyanions and/or polycations in the dipping procedures, it is possible to obtain layers having a structure ABCDABCD or else an irregular structure.

The polyelectrolytes are preferably applied by means of a simple dipping process. The composite material of the invention is preferably prepared by coating a composite material which has surface charges alternately with at least one anionic polyelectrolyte and at least one cationic polyelectrolyte. For this purpose the composite material which carries surface charges is dipped alternately into solutions of cationic and anionic polyelectrolytes. The first dipping process must involve the formation of a first layer onto which subsequent layers may be adsorbed.

If the surface of the composite material has negative charges, the first dipping process of the coating sequence comprises dipping the composite material into a solution comprising a cationic polyelectrolyte; if the surface of the composite material has positive charges, the first dipping process of the coating sequence comprises dipping the composite material into a solution comprising an anionic polyelectrolyte.

If the polyelectrolytes are coated on by a dipping process, it may be advantageous to leave the composite material which has surface charges in the polyelectrolyte solution for about half an hour. Following this dipping period, the composite material is preferably washed at least twice with water before subsequent dipping steps.

In each of the following dipping steps, a virtually monomolecular layer of the respective polyelectrolyte is deposited on a surface having the opposite charge. The conformation of the deposited polyelectrolyte depends greatly on whether low molecular mass salts, such as NaCl, for example, are added as electrolytes to the polyelectrolyte solution. Without the addition of electrolyte, the polyelectrolytes are deposited in an approximately expanded conformation; with the addition of electrolyte, they are deposited in a clustered conformation. By depositing polyelectrolytes in the clustered conformation it is possible to obtain thicker polyelectrolyte layers. The thickness of the deposited layer is therefore much greater with addition of electrolyte than without. The bonding between the polyelectrolytes is attributable exclusively to physical interactions between the polyelectrolytes. By far the greatest attracting force is the interaction between the differently charged ionic groups of the polyelectrolytes. The most important variable influencing the pervaporation performance of polyelectrolyte membranes is the charge density; that is, the number of carbon atoms per charge. Polyelectrolytes used for the process of the present invention are preferably those in which the polyelectrolyte layer has a ratio of carbon atoms to possible ion pair bonds of from 2:1 to 20:1, preferably from 4:1 to 8:1. Silicon atoms in polyelectrolyte layers comprising organosilicon polyelectrolytes may be counted as if carbon atoms.

Preferred polyelectrolytes may include, for example, poly(allylamine hydrochloride), poly(ethyleneimine), polyvinylamine, polyvinyl sulfate potassium salt, poly(2-acryloamido-2-methyl-1-propanesulfonic acid), polyacrylic acid, cellulose sulfate potassium salt, chitosan, poly(4-vinylpyridine), poly(styrenesulfonate) sodium salt, and dextran sulfate sodium salt. Particularly preferred cationic polyelectrolytes include polyallylamine hydrochloride, polyethyleneimine and/or polyvinylamine. Particularly preferred anionic polyelectrolytes include polyacryloamido-2-methyl-1-propanesulfonic acid and/or polyvinyl sulfate potassium salt.

In a third embodiment, the present invention provides for a method of separating mixtures, for example alcohol/water mixtures, especially ethanol/water mixtures, by pervaporation and vapor permeation with the composite material of the present invention. In particular, the composite materials of the present invention may be used as pervaporation membranes.

The separation of water and ethanol by pervaporation is particularly important. It is possible, using the composite material of the present invention for example, to separate water from ethanol with a separation factor of up to 500 for flow rates through the membrane of up to 11,000 g/m²h, at temperature of about 80° C. and a pressure difference of about 1 bar. The feed stream contained between 3 and 18% water in ethanol.

In addition, the polyelectrolyte coated composite material of the present invention may be used as a membrane in solvent drying, since in this application the membrane materials employed at present are frequently limited, owing to the swelling behavior of the support polymers and their relatively low thermal stability, to a few solvents (ethanol and the like) and to temperatures below 80° C. Using the composite material of the invention as a membrane, it is also possible to dewater solvents such as, for example, THF, methylene chloride or acetone.

The greater thermal stability of the polyelectrolyte coated permeable composite materials of the present invention, compared to conventional membranes, allows the composite materials of the present invention to be used, furthermore, in pervaporation at temperatures higher than those of state of the art processes, such as the treatment of component streams after rectification. The huge technical advantage obtained by using the composite materials of the present invention is that the component streams to be treated no longer need to be passed through heat exchangers before contacting a pervaporation membrane, but instead can be passed directly to a pervaporation membrane at the respective process temperature (which may be up to 110° C.), at which temperature vapor permeation is frequently occurs, as well. In other words, the incoming stream is passed in the vapor state over the membranes. The polyelectrolyte coated composite materials of the invention are also suitable as membranes for such applications owing to their increased temperature stability in relation to conventional polyelectrolyte membranes.

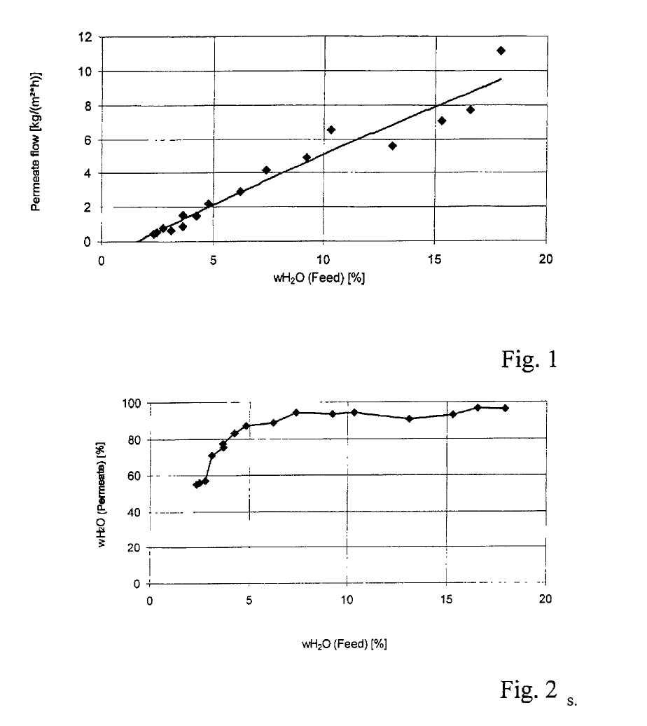

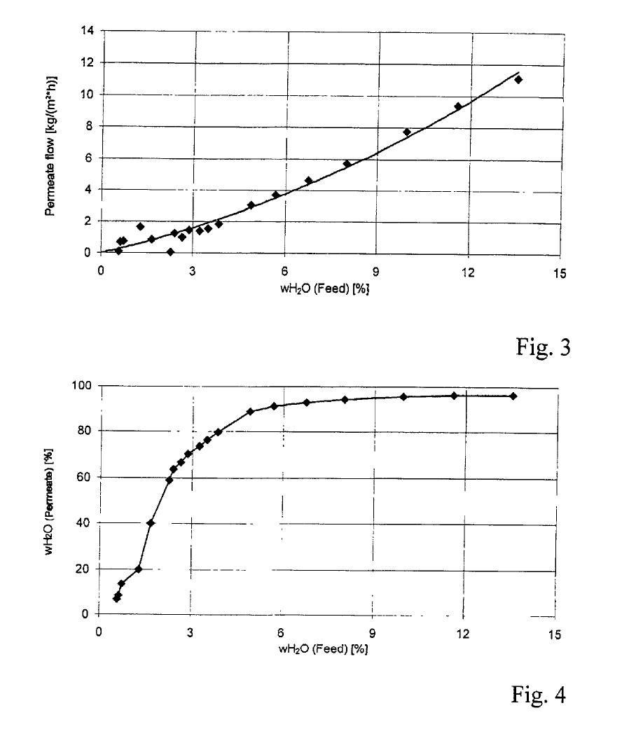

The values plotted in FIGS. 1 to 4 are measurements obtained when using a membrane of the present invention for the separation of ethanol/water mixtures. FIGS. 1 and 3 show the permeate flow as a function of the initial water content in the ethanol/water mixture of the feed. FIGS. 2 and 4 show the water content in the permeate, in % by weight, as a function of the initial water content in the ethanol/water mixture of the feed. The measurements plotted in FIGS. 1 and 2 were obtained in the course of conducting the experiment from Example 3c, at a temperature of about 80° C. The measurements plotted in FIGS. 3 and 4 were obtained in the course of conducting the experiment from Example 3c, at a temperature of from about 105 to 110° C.

The polyelectrolyte coated composite materials of the present invention, the process for preparing them, and their use are described by means of the following examples, without being restricted thereto.

### EXAMPLES

### Example 1.1

### Preparation of a Composite Material as per PCT/EP98/05939

a) 120 g of titanium tetraisopropoxide were stirred vigorously with 140 g of deionized ice until the resultant precipitate was very finely divided. Following the addition of 100 g of 25% strength hydrochloric acid, stirring was continued until the phase became clear. 280 g of α-aluminum oxide of the type CT300SG from Alcoa, Ludwigshafen, were added, and the mixture was stirred for a number of days until the aggregates broke up. This suspension was subsequently applied in a thin layer to a stainless steel mesh with a mesh size of 90 μm and was solidified within a very short time at 550° C.

b) 40 g of titanium tetraisopropoxide were hydrolyzed with 20 g of water and the resulting precipitate was peptized with 120 g of nitric acid (25% strength).

This solution was stirred until it clarified, and following the addition of 40 g of titanium dioxide from Degussa (P25) stirring was continued until the agglomerates broke up. After a further 250 ml of water had been added to the suspension, it was applied to a porous support (prepared in accordance with Example 1.la) and solidified within a very short time at approximately 500° C.

### Example 1.2

### Preparation of an Ionic Composite Material

a) An inorganic permeable composite material as per Example 1.1 b was dipped into a solution of the following components: 5% Degussa Silan 285 (a propylsulfonic acid-triethoxysilane), 20% DI water in 75% ethanol. Prior to use it was necessary to stir the solution at room temperature for 1 hour. After excess solution had been allowed to drip away, the composite material was dried at from 80° C. to 150° C. and then used.

b) An inorganic permeable composite material as per Example 1.1 b was dipped into a solution of the following components: 5% Dynasilan 1172 from Degussa-Hüls, 2.5% hydrochloric acid (35% strength); 30% ethanol and 62.5% DI water. Prior to use it was necessary to stir the solution at room temperature for 30 minutes. After excess solution had been allowed to drip away, the composite material was dried at from 80° C. to 150° C. and then used.

c) 20 g of aluminum alkoxide and 17 g of vanadium alkoxide were hydrolyzed with 20 g of water and the resulting precipitate was peptized with 120 g of nitric acid (25% strength). This solution was stirred until it clarified and, following the addition of 40 g of titanium dioxide from Degussa (P25), was stirred until all of the agglomerates broke up. Following adjustment of the pH to about 6, the suspension was applied in a layer 100 μm thick to an E-glass cloth type 1675 from CS-Interglas and dried at 500° C. within 1 minute. This gave a composite material furnished with negative fixed charges.

d) 20 g of tetraethyl orthosilicate and 17 g of potassium permanganate were hydrolyzed with 20 g of water and reduced completely with 6% strength hydrogen peroxide solution. The resulting precipitate was partially peptized with 100 g of sodium hydroxide solution (25% strength). This solution was stirred for 24 hours and, following the addition of 40 g of titanium dioxide from Degussa (P25), was stirred until all of the agglomerates broke up. After the pH had been adjusted to about 8, the suspension was applied to a permeable support having a pore size of about 0.1 μm (from Atech, Essen).

This support was then dried at 500° C. within 1 minute. This gave a composite material having negative fixed charges.

### Example 2

### Polyelectrolyte Coated Composite Material

a) A composite material made ionic in accordance with 1.2a was coated with polyelectrolytes, the coating taking place by dipping, with one side of the membrane being masked off, so that coating was effected on one side only. To this end the composite material was first immersed for 30 minutes in a solution of polyethyleneimine (0.01 mmol/l in aqueous HCl, pH 1.7) and then cleaned by twofold immersion in water. The composite material was then immersed for 30 minutes in a solution consisting of 0.01 mmol/l polyvinyl sulfate potassium salt (in aqueous HCl, pH 1.7) and subsequently washed twice with water. The dipping operation in the polyethyleneimine solution was then repeated. The alternate immersion in the polyethyleneimine and the polyvinyl sulfate sodium salt solution was carried out 60 times per solution. The membrane was subsequently dried in a circulating-air drying cabinet at 90° C. for 24 h and was suitable for use as a membrane in a pervaporation cell.

b) In accordance with Example 2a, composite materials made ionic in accordance with Example 1.2a were coated with different polyelectrolytes, coating taking place by dipping with one side of the membrane masked off so that coating was effected on one side only. The membranes thus prepared were used for pervaporation. The pervaporation took place at a temperature of 58.5° C. and at a pH of 1.7. An ethanol/water mixture having a water content of 6.2% by weight was used. Table 1 lists the polyelectrolyte solutions used in each case with the compounds used as polycations or polyanions, respectively, the number of dipping cycles, and also the flow data, water contents of the permeate, and separation factors. All of the membranes or polyelectrolyte coated composite materials prepared in this way are suitable for use as pervaporation membranes for separating ethanol and water or for removing water from organic solvents.

c) In accordance with Example 2a, composite materials made ionic in accordance with Example 1.2a were coated with different polyelectrolytes, coating taking place by dipping with one side of the membrane masked off so that coating was effected on one side only. However, the dipping solutions of Example 2c differ from those of Example 2a, in that both polyelectrolyte solutions additionally contained NaCl at a concentration of 1 mol/l. The membranes thus prepared were used for pervaporation. The pervaporation took place at a temperature of 58.5° C. and at a pH of 1.7. An ethanol/water mixture having a water content of 6.2% by weight was used. Table 1 again lists the polyelectrolyte solutions used in each case with the compounds used as polycations or polyanions, respectively, the number of dipping cycles, and also the flow data, water contents of the permeate, and separation factors. All of the membranes or polyelectrolyte coated composite materials prepared in this way are suitable for use as pervaporation membranes for separating ethanol and water or for removing water from organic solvents.

d) A composite material made ionic in accordance with 1.2a was coated with polyelectrolytes, the coating taking place by dipping, with one side of the membrane masked off, so that coating was effected on one side only. To this end the composite material was first immersed for 30 minutes in a solution of polyvinylamine (0.01 mmol/l in aqueous HCl, pH 1.7) containing NaClO₄ in a concentration of 1 mol/l and then cleaned by twofold immersion in water. The composite material was then immersed for 30 minutes in a solution consisting of 0.01 mmol/l polyvinyl sulfate potassium salt (in aqueous HCl, pH 1.7) likewise containing NaClO₄ in a concentration of 1 mol/l and subsequently washed twice with water. The dipping operation in the polyvinylamine solution was then repeated. The alternate immersion in the polyvinylamine and the polyvinyl sulfate sodium salt solution was carried out 30 times per solution, so that 60 layers were applied to the composite material. The membrane was subsequently dried in a circulating-air drying cabinet at 90° C. for 24 h and was suitable for use as a membrane in a pervaporation cell.

TABLE 1
Polyelectrolyte solutions used in Experiments 2b and 2c, number of
dipping cycles, flow data, water contents of the permeate, and
separation factors.

| | | Number of | | | |
|---|---|---|---|---|---|
| | | dipping | Flow | H₂Oₚₑᵣₘₑₐₜₑ | |
| Polycation | Polyanion | cycles | [g/m²h] | [% by wt.] | α |
| PEI | PVS | 60 | 159 | 61.6 | 24.3 |
| PVAM | PVS | 60 | 316 | 70.3 | 35.8 |
| PAH | PAMSA | 60 | 216 | 62.0 | 24.7 |
| PVAM + | PVS + | 30 | 693 | 51.1 | 15.8 |
| (1 mol/1 | (1 mol/1 | | | | |
| NaCl) | NaCl) | | | | |
| PVAM + | PVS + | 45 | 308 | 77.3 | 51.6 |
| (1 mol/1 | (1 mol/1 | | | | |
| NaCl) | NaCl) | | | | |
| PVAM + | PVS + | 60 | 210 | 91.0 | 153 |
| (1 mol/1 | (1 mol/1 | | | | |
| NaCl) | NaCl) | | | | |

Key:
PEI: Poly(ethyleneimine)
PVS: Poly(vinyl sulfate potassium salt)
PVAM: Poly(vinylamine)
PAMSA: Poly(2-acrylamido-2-methyl-1-propanesulfonic acid)
PAH: Poly(allylamine hydrochloride)

The separation factor α is the ratio of the composition of the permeate (p) to the composition of the feed (f), i.e.:

α=([H₂O]p/[ethanol]p)/([H₂O]f/[ethanol]f)

### Example 3

### Examples of Separations using the Composite Materials of the Present Invention

a) The polyelectrolyte coated composite material of Example 2a was used to separate a mixture of 94% ethanol and 6% water. The flow through the polyelectrolyte coated composite material membrane was 159 g/m²h, with an ethanol content of about 30 to 40% in the permeate. The temperature of the retentate was 58.5° C. and the permeate pressure was 15 mbar.

b) The polyelectrolyte coated composite material of Example 2c using polyvinylamine as the polycation and polyvinyl sulfate as the polyanion was used to separate the same mixture as in Example 3a, under the same temperature conditions. The flow was 210 g/m²h, with an ethanol content in the permeate of 9%.

c) A polyelectrolyte coated composite material prepared as in Example 2d was used to separate different mixtures of water and ethanol at a temperature of 80° C. FIG. 1 is a plot of permeate flow as a function of water content in the mixture to be separated (feed). FIG. 2 is a plot of the water content of the permeate as a function of the water content in the feed.

It is clearly evident that at a temperature of 80° C. a feed containing about 5% water and about 95% ethanol may be separated with a permeate flow of about 2000 g/m²h, such that the permeate has a water content of about 88% and an ethanol content of about 12%.

d) The experiment from Example 3c was repeated at a temperature of from 105 to 110° C. FIG. 3 is a plot of permeate flow as a function of water content in the feed. FIG. 4 is a plot of the water content of the permeate as a function of the water content in the feed.

It is clearly evident that at a temperature of 105 to 110° C. a feed containing about 5.5% water and about 94.5% ethanol may be separated with a permeate flow of about 4000 g/m²h, such that the permeate has a water content of about 92% and an ethanol content of about 8%.

Obviously, numerous modifications and variations on the present invention are possible in light of the above teachings. It is therefore to be understood that within the scope of the appended claims, the invention may be practiced otherwise than as specifically described herein.

The priority document of the present application, German application 10031281.0, filed Jun. 27, 2001, is incorporated herein by reference.

What is claimed as new and intended to be secured by Letters Patent is:

1. A polyelectrolyte coated permeable composite material comprising a composite material having inner and outer surfaces comprising at least one permeable support and at least one inorganic component disposed on at least one side and on inner surfaces of the support, and
a polyelectrolyte disposed on the inner and/or outer surfaces of the composite material,
wherein the inorganic component comprises at least one compound of a metal, semimetal or mixed metal with at least one element from main groups 3 to 7.

2. The polyelectrolyte coated permeable composite material of claim 1, further comprising at least one organic and/or inorganic material which has surface charges.

3. The polyelectrolyte coated permeable composite material of claim 2, wherein the organic and/or inorganic material has surfaces having ionic groups on which a polyelectrolyte layer can be adsorbed.

4. The polyelectrolyte coated permeable composite material of claim 2, wherein the organic material which carries surface charges comprises at least one polymer.

5. The polyelectrolyte coated permeable composite material of claim 4, wherein the polymer is selected from the group consisting of a sulfonated polytetrafluoroethylene, sulfonated polyvinylidene fluoride, aminated polytetrafluoroethylene, aminated polyvinylidene fluoride, sulfonated polysulfone, aminated polysulfone, sulfonated polyetherimide, aminated polyetherimide or a mixture thereof.

6. The polyelectrolyte coated permeable composite material of claim 2, wherein the inorganic material is at least one compound selected from the group consisting of oxides, phosphates, phosphites, phosphonates, sulfates, sulfonates, vanadates, stannates, plumbates, chromates, tungstates, molybdates, manganates, titanates, silicates, aluminosilicates and aluminates or mixtures of these compounds of at least one of the elements Al, K, Na, Ti, Fe, Zr, Y, Va, W, Mo, Ca, Mg, Li, Cr, Mn, Co, Ni, Cu and Zn or mixtures of these elements.

7. The polyelectrolyte coated permeable composite material of claim 6, wherein the inorganic material is at least one amorphous and/or crystalline compound, having groups some of which cannot be hydrolyzed, of at least one element selected from the group consisting of Zr, Si, Ti, Al, Y or vanadium or a mixture of these elements or compounds.

8. The polyelectrolyte coated permeable composite material of claim 1, wherein the polyelectrolyte comprises polyelectrolytes which carry negative and/or positive charges.

9. The polyelectrolyte coated permeable composite material of claim 1, wherein the polyelectrolyte comprises a plurality of alternating anionic and cationic polyelectrolytes.

10. The polyelectrolyte coated permeable composite material of claim 1, wherein the polyelectrolyte comprises at least one polyelectrolyte selected from the group consisting of polyallylamine hydrochloride, polyethyleneimine, polyvinylamine, polyvinyl sulfate potassium salt, polystyrenesulfonate sodium salt, and polyacrylamido-2-methyl-1-propanesulfonic acid.

11. The polyelectrolyte coated permeable composite material of claim 1, wherein the polyelectrolyte has a ratio of carbon atoms to possible ion pair bonds of from 2:1 to 20:1.

12. The polyelectrolyte coated permeable composite material of claim 11, wherein the polyelectrolyte has a ratio of carbon atoms to possible ion pair bonds of from 4:1 to 8:1.

13. The polyelectrolyte coated permeable composite material of claim 1, wherein the polyelectrolyte coated permeable composite material is flexible.

14. The polyelectrolyte coated permeable composite material of claim 1, wherein the polyelectrolyte coated permeable composite material can be bent to a minimum radius of 5 mm.

15. A process for preparing the polyelectrolyte coated permeable composite material of claim 1 comprising:
preparing a composite material having surface charges and inner and outer surfaces; and
coating a polyelectrolyte one or more times on at least one side and/or on the inner surfaces of the composite material
wherein the composite material comprises at least one permeable support and at least one inorganic component comprising at least one compound of a metal, semimetal or mixed metal with at least one element from main groups 3 to 7.

16. The process of claim 15, wherein the composite material having surface charges is prepared by treated a composite material having no surface charges with at least one material having surface charges or with at least one material having surface charges after additional treatment.

17. The process of claim 15, wherein the composite material having surface charges is obtained by treating a composite material which has a pore size of from 0.001 to 5 μm and has no surface charges with at least one material which has surface charges or with at least one material which has surface charges after additional treatment.

18. The process of claim 16, wherein said treating is a method selected from the group consisting of impregnating, dipping, brushing, roller application, knife coating, and spraying.

19. The process of claim 16 , wherein the composite material is thermally treated after treating the composite material having no surface charges with at least one material which has surface charges or at least one material which has surface charges after additional treatment.

20. The process of claim 19, wherein the thermal treatment is conducted at a temperature from 100 to 700° C.

21. The process of claim 16, wherein the material having surface charges or the material which has surface charges following additional treatment is applied in the form of a solution having a solvent content of from 1 to 99%.

22. The process of claim 16, wherein said material having surface charges comprises Brönsted acids or Brönsted bases.

23. The process of claim 16, wherein said material having surface charges comprises at least one polymer-bound Brönsted acid or Brönsted base.

24. The process of claim 15, wherein the inorganic component is at least one sol which comprises polyelectrolyte solutions or polymer particles which carry fixed charges.

25. The process of claim 24, wherein the sol further comprises at least one material which has surface charges or at least one material which has surface charges after additional treatment.

26. The process of claim 25, wherein the sol is prepared by hydrolyzing at least one metal compound, at least one semimetal compound or at least one mixed metal compound or a combination of these compounds with a liquid, a gas and/or a solid.

27. The process of claim 24, wherein the sol further comprises nonstoichiometric metal, semimetal or nonmetal oxides or hydroxides produced by changing the oxidation state of the corresponding element.

28. The process of claim 24, wherein the sol further comprises substances which lead to the formation of inorganic structures which have surface charges.

29. The process of claim 15, wherein the composite material is coated from 1 to 500 times with at least one organic polyelectrolyte.

30. The process of claim 29, wherein the composite is coated from 20 to 100 times with at least one organic polyelectrolyte.

31. The process of claim 29, wherein the composite material is coated alternately with at least one anionic polyelectrolyte and at least one cationic polyelectrolyte.

32. The process of claim 31, wherein the cationic polyelectrolyte is selected from the group consisting of polyallylamine hydrochloride, polyethyleneimine and polyvinylamine.

33. The process of claim 31, wherein the anionic polyelectrolyte is selected from the group consisting of polyacrylamido-2-methyl-l-propanesulfonic acid and polyvinyl sulfate potassium.

34. The process of claim 15, wherein the polyelectrolyte has the form of a dilute solution of a polyelectrolyte and an acid or base.

35. The process of claim 15, wherein the polyelectrolyte is coated by spraying, knife coating, roller application and/or dipping.

36. A method of separating a mixture by pervaporation, comprising contacting the mixture with the polyelectrolyte coated permeable composite material of claim 1.

37. A method of separating a mixture by vapor permeation, comprising contacting the mixture with the polyelectrolyte coated permeable composite material of claim 1.

38. The method of claim 36, wherein the mixture is an alcohol/water mixture.

39. The method of claim 37, wherein the mixture is an alcohol/water mixture.

40. The method of claim 36, wherein the alcohol is ethanol.

41. The method of claim 37, wherein the alcohol is ethanol.
